(19) United States
(12) Patent Application Publication
(10) Pub. No.: US 2011/0173064 A1
(43) Pub. Date: Jul. 14, 2011

(54) PERFORMANCE MEASUREMENT SYSTEM FOR OUT OF HOME MEDIA

(76) Inventor: Janice Lesiotis, River Forest, IL (US)

(21) Appl. No.: 12/685,364

(22) Filed: Jan. 11, 2010

(51) Int. Cl. G06Q 30/00; G06Q 10/00; G06F 3/048; G06F 17/30

(52) U.S. Cl. 705/14.45; 705/14.43; 705/14.42; 715/764; 707/781; 707/802; 707/E17.044; 707/E17.005

(57) ABSTRACT

A system and method for the evaluation and measurement of the performance of out of home (OOH) media is disclosed. The disclosed system may provide a system for computer-based means consolidating in an easily accessed format, information that has relevance to the marketing process of a particular brand or product and the performance measurement of a users outdoor media campaign.

### FIELD OF THE INVENTION

The invention relates generally to a system and method for the evaluation and measurement of the performance of outdoor advertisements in order to provide, for example, confirmation of ad placement and value-added relevance to marketing information.

### BACKGROUND AND SUMMARY OF THE INVENTION

The term out of home (“OOH”) media is commonly used in the advertising industry to refer to billboards, wall advertisements, and other types of media or advertising displays that may be found outside of a consumer's home. Often, such media is positioned in locations that are desirable for the advertiser, but do not necessarily have proximity to the advertiser. For example, a cruise ship company headquartered in the Bahamas, that departs out of Florida, may desire to advertise its cruises in a land-locked location, such as the Midwest, knowing that it receives value from advertising to potential customers in the area.

In many cases such as this, an advertiser or advertising agency may directly or in-directly lease or purchase the media display sight-unseen from an OOH media supplier. Advertisers may be given a description of the display, size, general location or viewership statistics, but may not actually visit the display or personally confirm that the advertisement was accurately represented by and placed as ordered by the OOH media supplier.

A common method of proving the placement of the advertisement is for representatives of the OOH media supplier, or vendor, to capture a still digital image of the display, generate a completion report and provide the image and report to purchaser via email or server download. As used herein, the terms “media supplier” and “vendor” relate generally to entities that provide out-of-home advertising space and services to third parties. The provided report and accompanying photograph are commonly referred to as Proof of Performance or POP. Generally, reports include only the date of installation, while other performance statistics or display metrics are not included.

The disclosed invention sets forth an apparatus, system and method for the evaluation and measurement of the performance of outdoor advertisements in order to provide confirmation of ad placement and value added relevance to marketing information.

### BRIEF DESCRIPTION OF THE DRAWINGS

FIG. 1 shows examples of data collected in one illustrated embodiment of the invention disclosed herein;

FIG. 2 is an example of a workflow or process that can be followed for collecting data, processing, and reporting the data collected;

FIG. 3 is a table exemplifying the types of data that may be provided by a user /customer;

FIG. 4 is a table showing the types of data that a field agent can provide via on-site visits;

FIG. 5 is an example of another table that can be completed by a field agent relating to the illumination and visibility of the media;

FIG. 6 shows an example of a report that can be provided to a customer;

FIG. 7 is a flow chart of pages that may be viewed by a user;

FIG. 8 is an example of views that can be provided in a dashboard or user interface;

FIG. 9 is an example of a geographic report showing results as they relate to demographics and/or geographics;

FIG. 10 is an example of how the apparatus, system, and methods disclosed herein interact; and

FIG. 11 is an example of the steps that can be taken to implement one embodiment of the present invention.

### DETAILED DESCRIPTION OF THE INVENTION

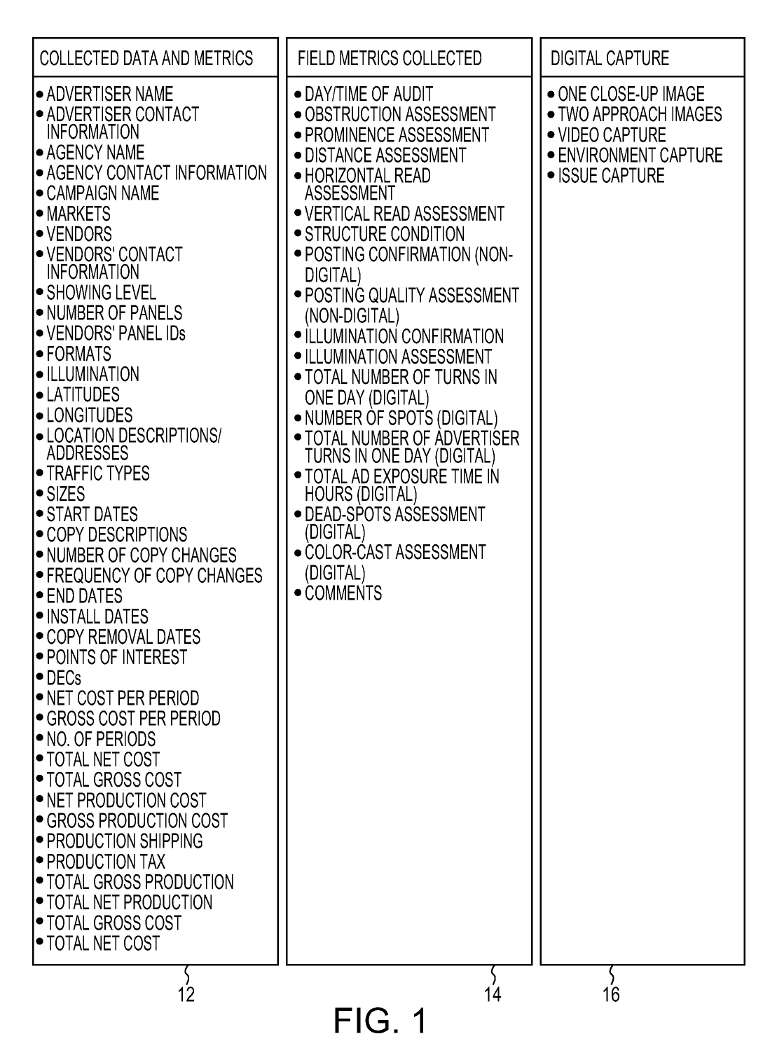

In one embodiment, an apparatus, system and method are provided that can be used to track OOH media data, analyze various aspects of the data, and report on the data. As can be seen in FIG. 1, the types of data that can be tracked may fall under the general categories of data and metrics 12, field metrics 14, and captured digital images 16.

The collected data and metrics category 12 can be obtained by an employee from interviews with the client, discussions with vendor/agents, from third-party databases and resources, and from personal inspection. Such data can then be collected, organized, and linked as discussed herein.

The types of information collected by a field agent or administration may include digital images (still or video) of a site, confirmation that an advertisement was placed in a manner as desired, confirmation that site illumination is operational, and an evaluation of the sight based on a pre-defined set of variables may be conducted. Illustratively, a measurement system for rating a display can be created and variables such as the distance of the site from the roadway, obstacles that may obstruct the visibility of the display, angle and height of the display can be used in calculating the rating, as disclosed further herein.

As set forth in detail herein, the present invention and process contemplates internal employees or third parties who act at field agents in order to perform such data collection. Each field agent may be assigned a specific geographic area in order to optimize the expense and time associated with information collection. A separate portion of the website may be dedicated to distributing and collecting sight information from field agents.

In such an example, the host may provide information via website login, e-mail, text, or other means such that a field agent can determine the location of the OOH media, can capture digital still or video images of the finished product, can rate display quality, can confirm lights are operational and can observe traffic flow or any other desirable characteristics of the location. The field agent may even be instructed to look for errors in the installation or placement of the advertisement.

It is contemplated that the presently disclosed apparatus and process may also include a communication means that permits a media vendor's billposter, operations manager, or other entity or representative to notify certain personnel when a particular advertisement has been completed and is ready for auditing. For example, this communication means may be a text, e-mail, phone, or website login service that permits a media vendor to notify the personnel of project completion. A unique ID number may be assigned to the placement at this time, or may have been pre-assigned during an earlier stage and referenced in this communication. Upon notification from the media vendor, the presently disclosed apparatus and process will illustratively update the system (i.e. the online database) to show the date and time for each display's posting. Of course, a plurality of displays may be transmitted in the same communication.

Field agents can be notified as soon as the notification from the media vendor has been completed and entered in the system. The field agent may be instructed to capture digital image(s), grade and/or rate the location, and upload image(s) to the host website along with placement evaluation and comments. The field agent may be instructed to do so within a pre-set period of time, such as within 24 hours of notification.

It is contemplated that the presently disclosed apparatus and process may also perform a performance analysis on uploaded data. In an illustrated example, a number of displays in a grouping of displays have in-operational lights. The percentage of non-illuminated displays and the resulting loss in audience viewership can then be calculated. In another illustrated example, the invention contemplates tracking and determining the installation progression and days lost or gained on the total contract days.

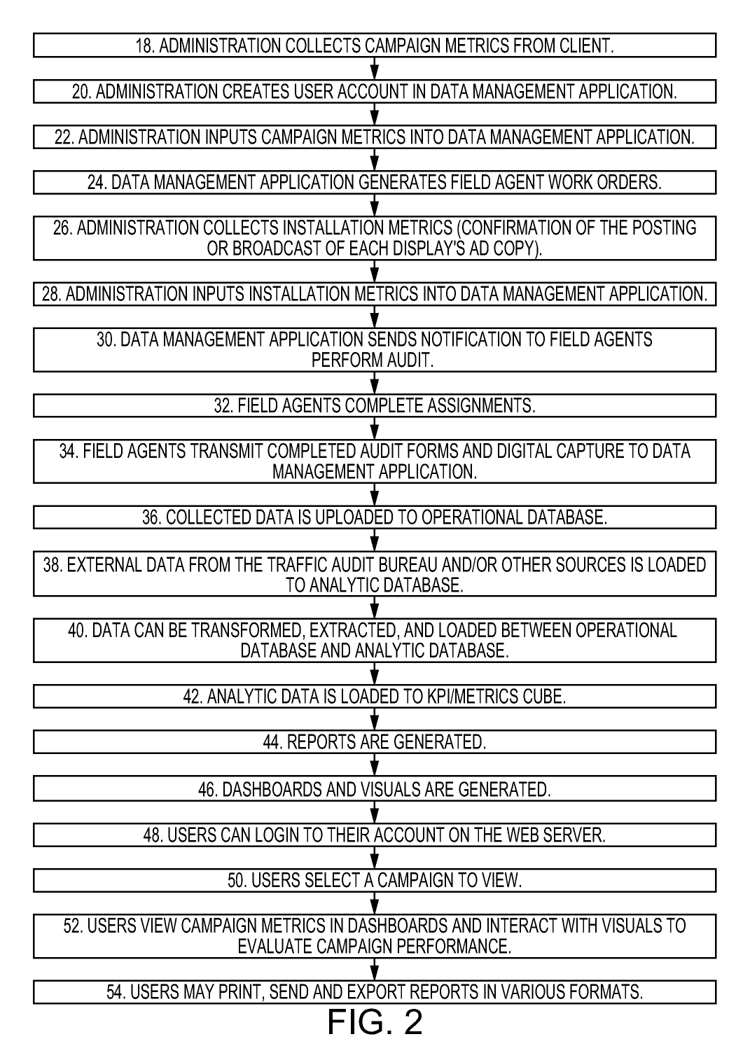

An illustrative workflow for processing the data is shown in FIG. 2. In one embodiment, the administration first collects 18 campaign metrics from the client. Such campaign metrics may be, for example, the advertiser name, contact information, agency name, campaign name, markets, vendors, etc., as listed in FIG. 1. In the event some of these pieces of data are not known, they can be suggested by administration or supplied at a later point.

Using the data collected in step 18, an administrator can create a user account in the data management application, outlined in step 20, and input the campaign metrics according to step 22. The data management application can then generate field agent work orders automatically, or it can provide prompts to a user for what types of field agent work orders should be produced, pursuant to step 24.

The administration can also collect and input installation metrics, as set forth in steps 26 and 28, respectively. The installation metrics may include information relating to where the OOH media will be located, when it will be installed, etc. A notification can then be sent to field agents to perform an audit, pursuant to step 30.

As set forth in step 32, it is contemplated that field agents (working for the administration) will complete the assignments for which notifications were sent within a set time period. This time period may be set as a preexisting timeframe by the administration, or may be provided in the notification. The assignments may require that a field agent visit a OOH media location a plurality of times, for example to confirm the exact date of the week that the media was placed.

Field agents can then transmit completed audit forms and digital capture to a data management application, as set forth in step 34. This can be done via FTP, a portable hand-held device, or via any other data transmission means known in the art.

Data can then be uploaded to an operational database pursuant to step 36. Data from third-party sources, such as a traffic audit bureau or other sources, can also be loaded to an analytic database per step 38. The data in the operational database and the analytic database may be interchanged, loaded, extracted, or transformed for further analysis as set forth in step 40.

Analytic data may also be loaded into the KPI/metrics cube, as suggested by step 42. Such a KPI/metrics cube is where data can be aggregated and made available for fast analysis. Key performance indicators can also be defined and identified in the metrics cube.

Once all data is loaded and/or processed, the disclosed invention contemplates that a performance report may be created, as set forth in step 44. The report can be generated or delivered in any number of ways, such as via an online “dashboard” and/or via visual representations, as contemplated by step 46.

In one embodiment, the invention contemplates that reports can be viewed via a web-based login to a server, as set forth in step 48. Once logged in, a user can select a campaign to view, as set forth in step 50. Users can also view campaign metrics in the dashboards, and/or interact with visuals to better evaluate the performance of their campaign(s), as set forth in step 52. Finally, a user may print or export its report(s) as contemplated by step 54.

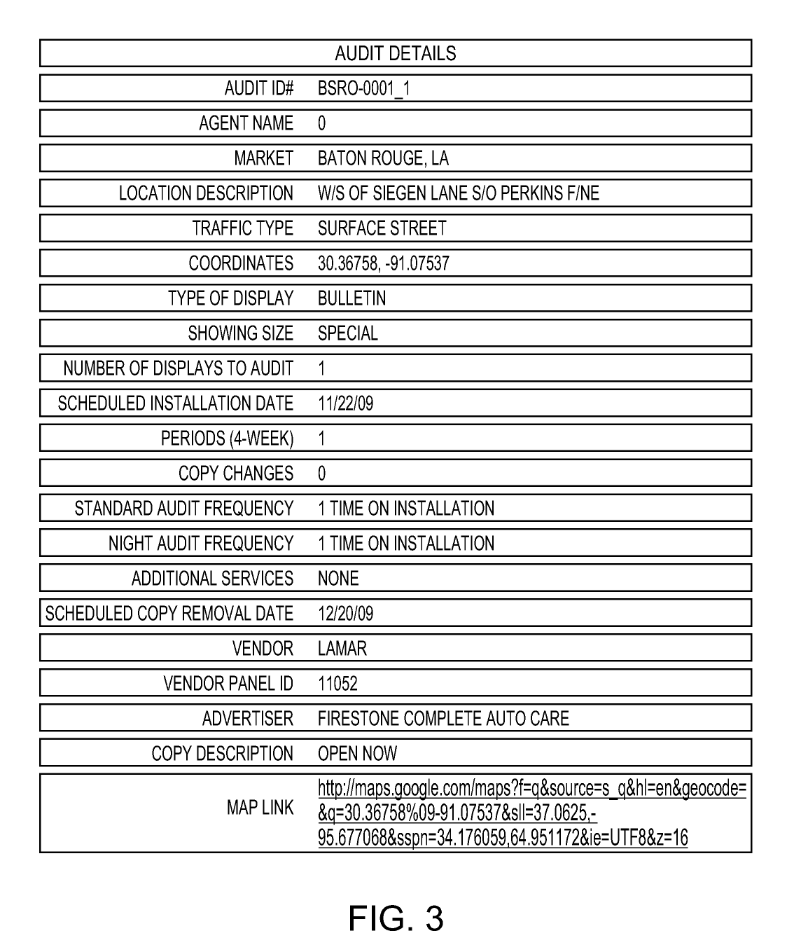

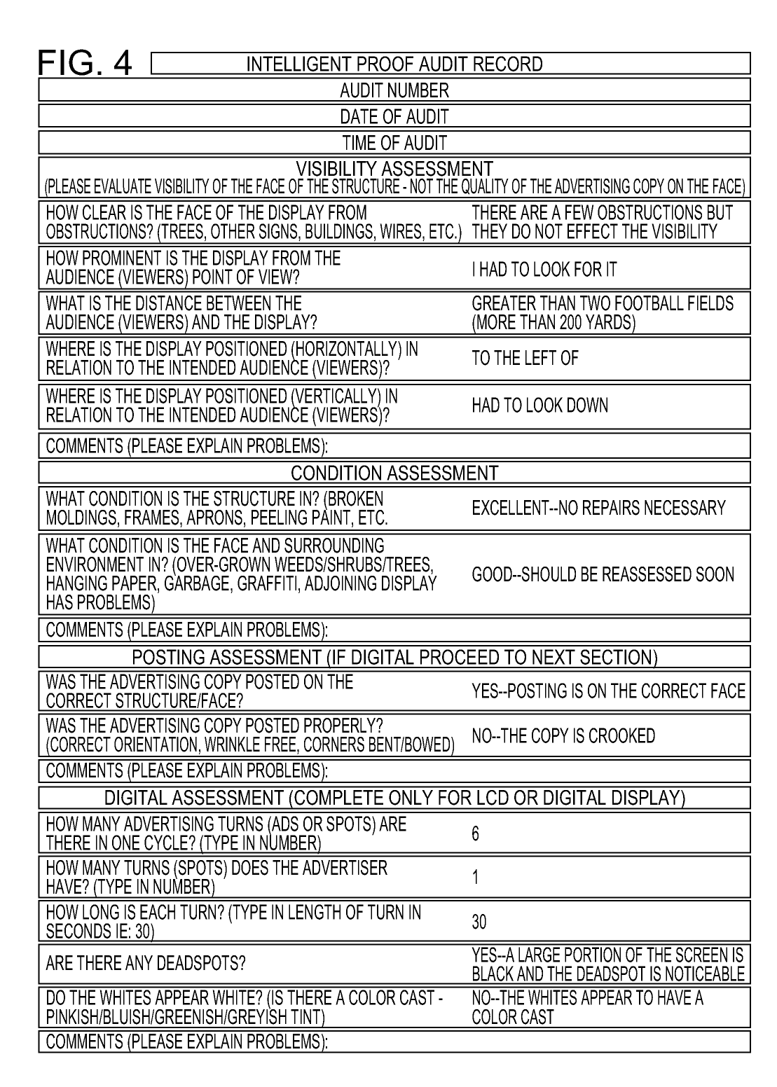

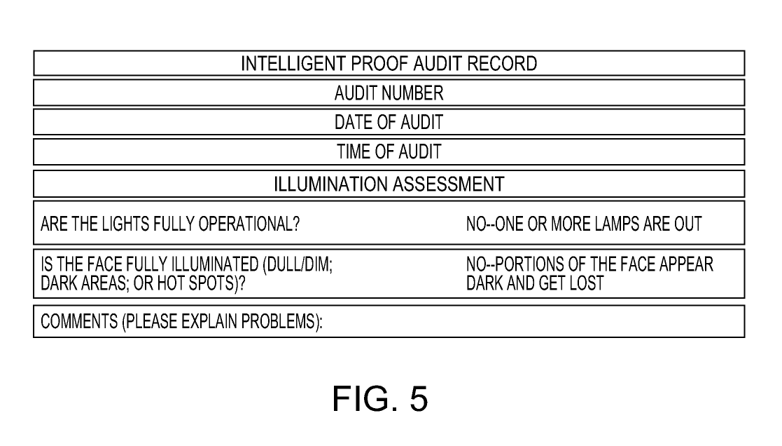

FIG. 3 illustrates an example of certain audit details for a single OOH customer, showing various types of data that is either collected or input by the user. FIG. 4 shows a standard survey that may be completed by a field agent. FIG. 5 shows a survey that can also be completed by a field agent for assessment of the illumination of the OOH media. The surveys shown in FIGS. 4-5 may be constructed to have pop-up or pre-determined menus, and may be completed on a phone/handheld computer. It is contemplated these surveys may be completed during an on-site analysis done by the field agents.

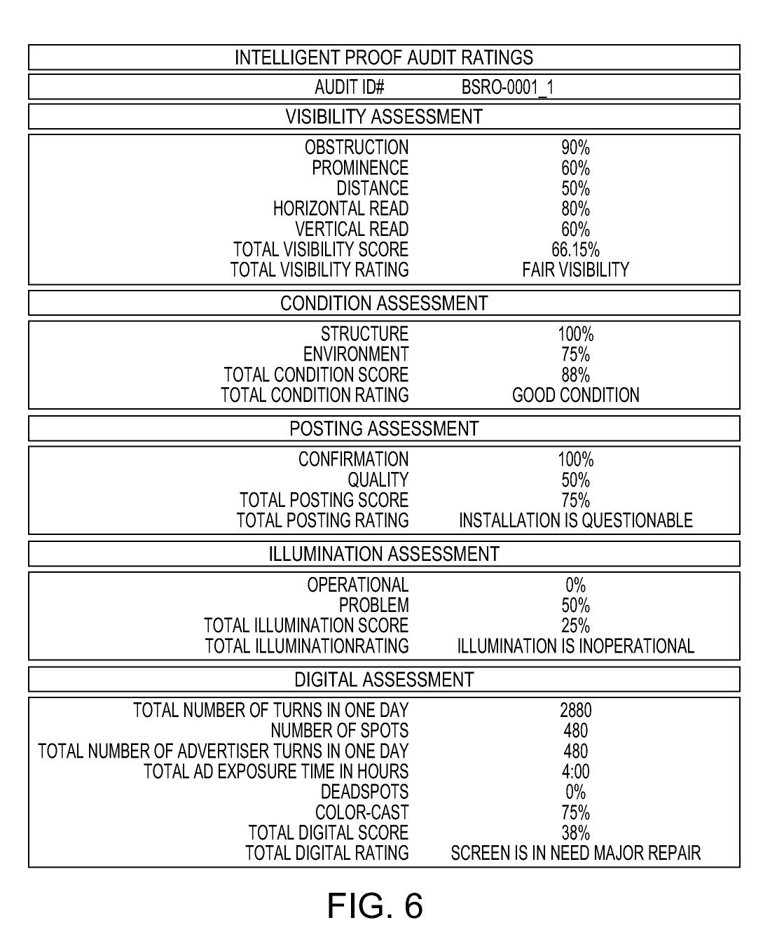

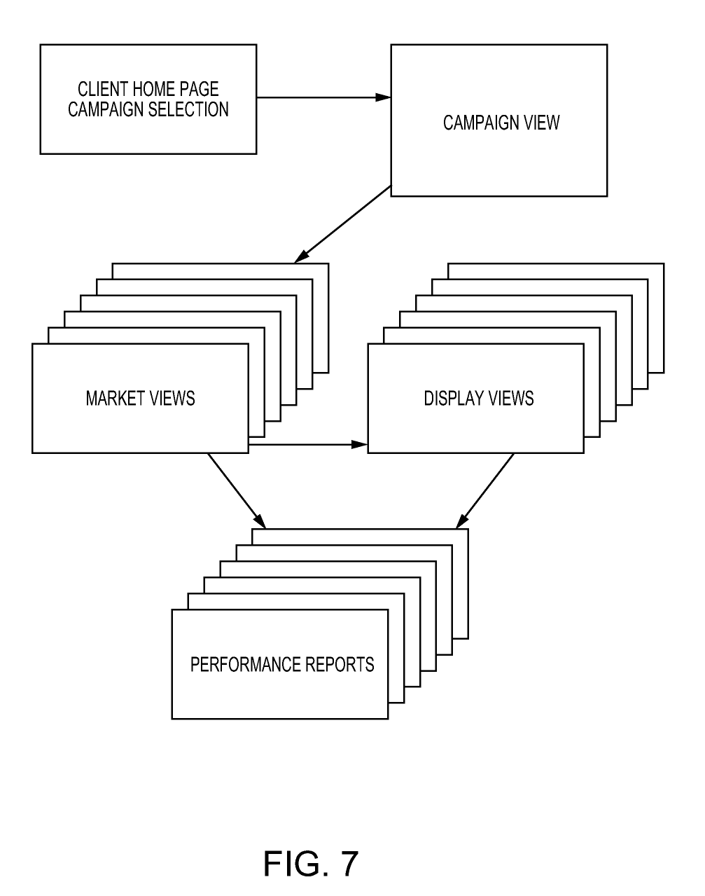

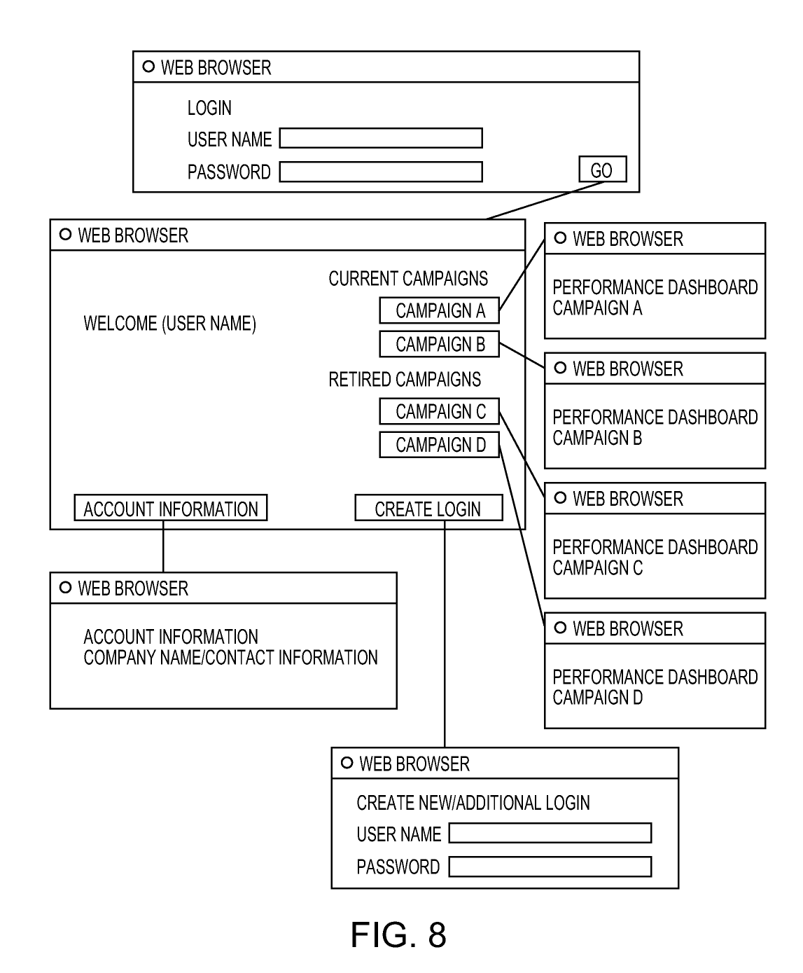

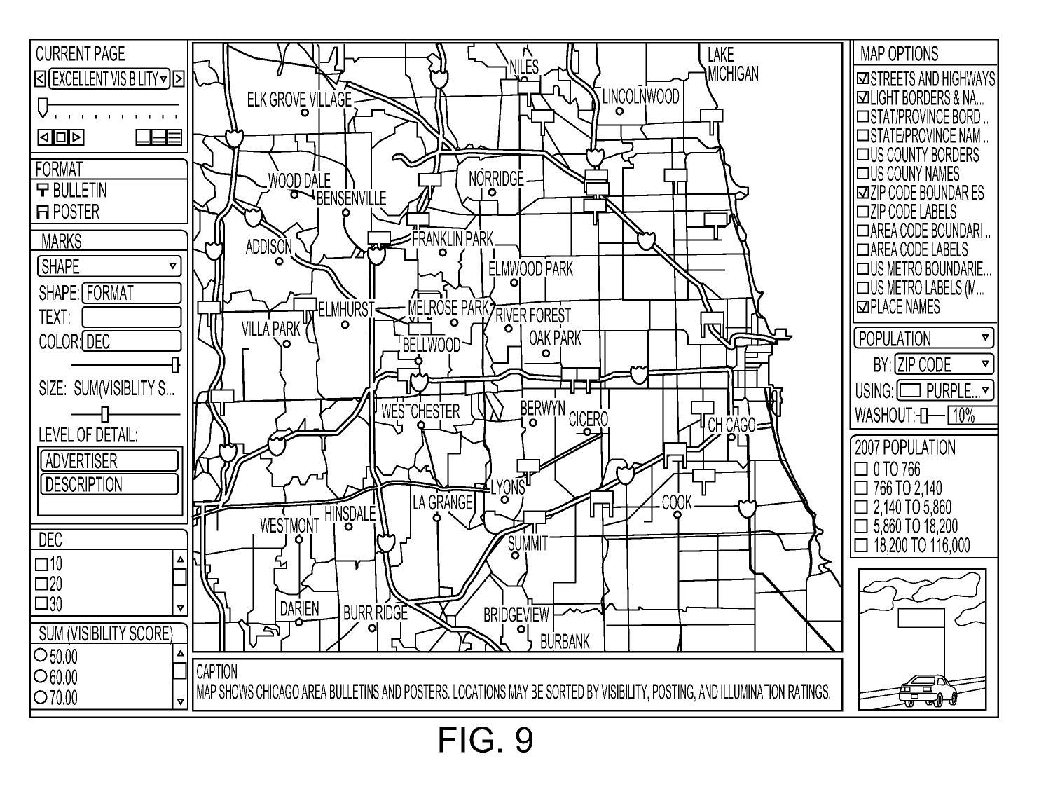

FIG. 6 illustrates an example of reported items (also referred to as scores) that may be included in the report generated by the method and system disclosed herein. FIG. 7 is an illustrative flow chart of the pages that may be viewed by a user and the order in which such pages may be presented or accessed. FIG. 8 also shows exemplary views for the dashboard /user interface contemplated by the present invention. FIG. 9 is an example of a graphical report that shows various types of information depicted geographically. Such information may include populations, demographics, media placement, types of media, types of media exposure, positions of user locations, or even competitor locations. Still other types of geographic information may be displayed, such a determination of what the target is, and how it geographically or demographically relates to the placement of the media. Percentages or miles outside of a target zone can also be calculated.

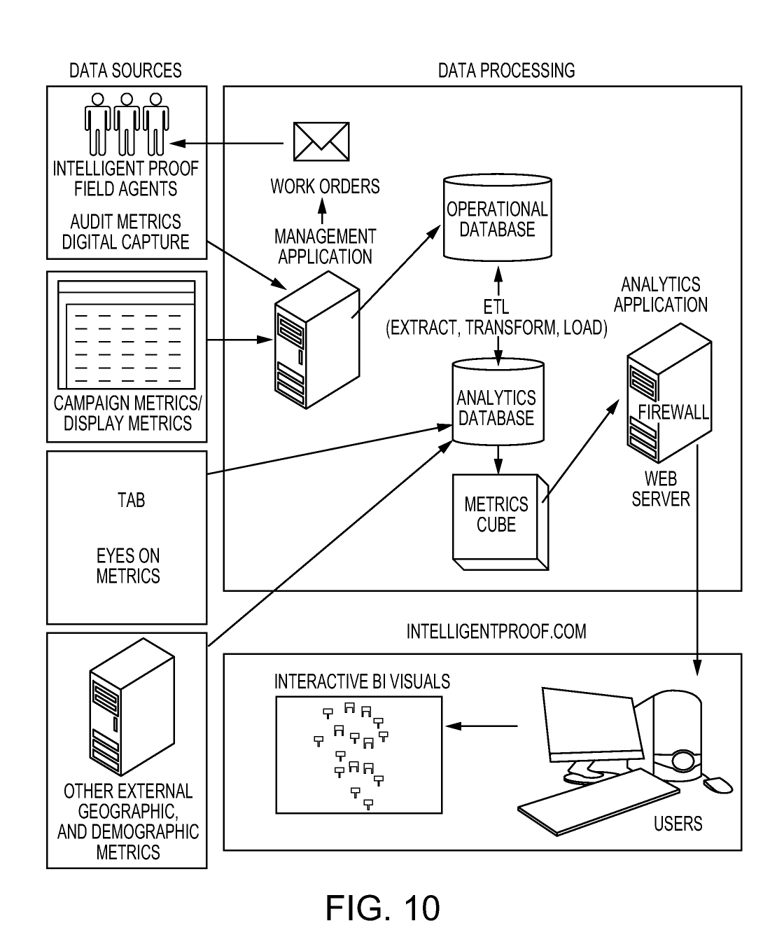

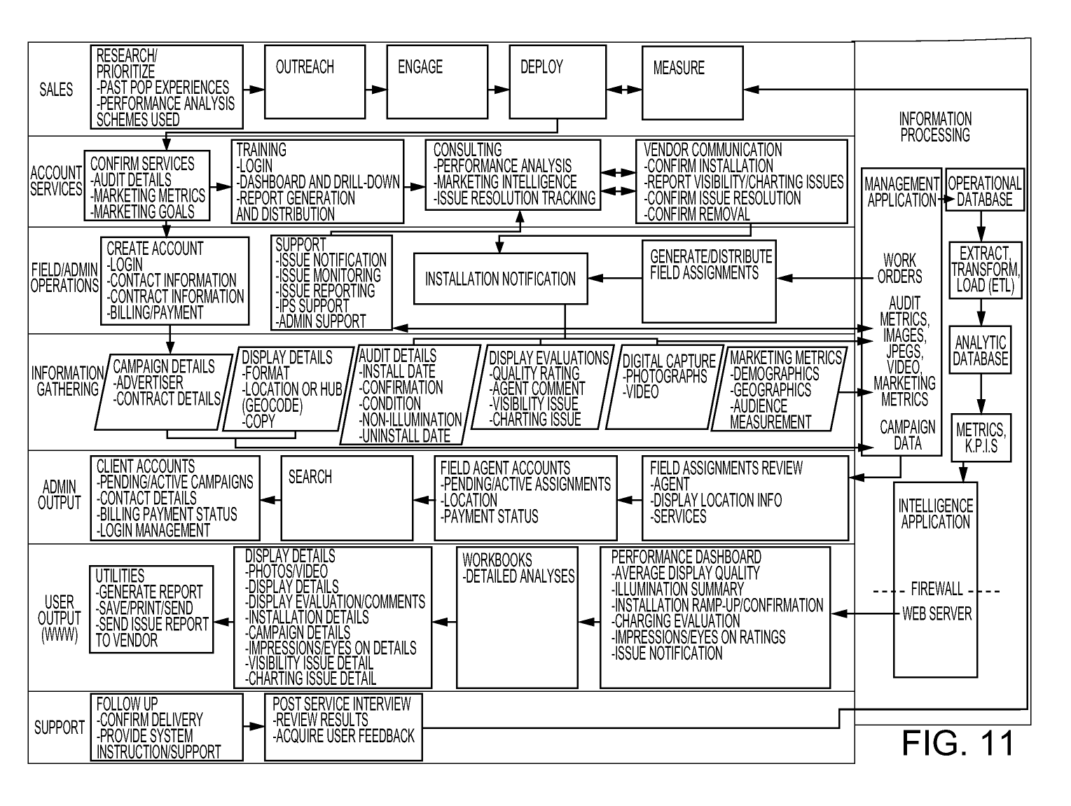

FIG. 10 shows how the system and method contemplated herein can be carried out by a combination of computer processors and servers. FIG. 10 shows additional resources that can be used, such as field agents and other external data sources. FIG. 11 also shows illustrative steps that can be taken to implement one embodiment of the invention disclosed herein.

According to one embodiment of the invention, a web site can be set up such that OOH media users can access an information data bank through a dashboard that displays the performance variables of an OOH media campaign in order to monitor a campaign, identify visibility issues, measure message impact, confirm installations, access audience measurement data, evaluate display distribution and point of interest intersection, and optimize OOH marketing spend and impact. Illustratively, a user can create a secure password-protected account with a host such as intelligentproof.com.

As noted above, the host may also provide a login for users to view collected sight information, corresponding image files, and performance analysis. Data may be viewed, for example, in a dashboard format with the ability to drill down to specific displays, as set forth in FIGS. 7-9. In another illustrated example, the user may generate a report and email the report to the vendor in order to report a problem with the placement and expedite a resolution.

Upon the removal of a placement, i.e. at the expiration of the contract, it is contemplated that the vendor's billposter or operations manager can call the host and text, enter on keypad, or speak to a host representative notifying the host of the removal. This can be done once again using the ID that was previously assigned, or using other means.

Upon notification, the host can update the system to reflect the removal date/time, and days over or under the total days in the campaign's contract. It may also be possible to automate various or all aspects of the process by using a computer or processor to gather the relevant data from a text, e-mail or data entry and automatically revise the database accordingly. The presently contemplated invention can also track vendors and trending for either promptness or tardiness.

Upon conclusion of a campaign, data may be saved or backed up to a different server for potential access at a later point. Data such as location, campaign information, evaluations and images can be saved to a searchable database creating a comprehensive resource for OOH media.

The invention provides a system, method, and apparatus that can collect and combine, in multidimensional databases, at least the following information:
campaign data: location information, cost metrics, markets, etc.;
field data: location, illumination, posting/digital evaluations, photos and video; and
audience metrics: TAB eye's on ratings, mapped geographic and demographic metrics, traffic counts, census information.

Once the information is collected and combined, the information can be analyzed and reports created having suggested courses of action. Furthermore, interactive dashboards can be provided that allow users to view and interpret data in various formats.

It is further contemplated that additional services may be provided and additional ratings provided through the present invention. For example, the creative aspect of the advertisement/media may be assessed. This may include graphical and literary aspects of the advertisement/media. The digital file or even the picture of the media may be requested. Key questions, with drop-down menus, can also be created for analyzing the creative.

While the disclosure is susceptible to various modifications and alternative forms, specific exemplary embodiments thereof have been shown by way of example and have herein been described in detail. It should be understood, however, that there is no intent to limit the disclosure to the particular embodiments disclosed, but on the contrary, the intention is to cover all modifications, equivalents, and alternatives falling within the spirit and scope of the disclosure and as further defined by any appended claims.

What is claimed is:

1. A method of providing data related to an out-of-home advertisement, the method comprising the steps of:
collecting campaign metrics related to an out-of-home advertising campaign;
providing a database for storing the collected campaign metrics;
creating a work order for a field agent that directs the field agent to verify information related to the out-of-home advertising campaign, wherein the information to be verified includes the date by which an out-of-home advertisement is posted;
providing an audit form to the field agent for recording information related to the out-of-home advertisement;
collecting information related to traffic and loading the information into the database; and
providing an analysis of the data collected via a report.

2. The method of claim 1, further comprising the step of providing an Internet-based user interface for access to the report.

3. The method of claim 1, further comprising the step of recording the visibility characteristics of the at least one out-of-home advertisement.

4. The method of claim 3, wherein the visibility characteristics comprise at least one characteristic from the group consisting of illumination, impediments to visibility, structural qualities, positioning relative to a viewer, traffic flow, pedestrian flow, aesthetic qualities of the advertisement, and surrounding geographic characteristics.

5. The method of claim 1, further comprising the step of providing a secure remote login enabling a customer to view the information or analysis in the database.

6. The method of claim 1, further comprising the step of comparing the locality of the at least one out-of-home advertisement with a point of interest.

7. The method of claim 6, wherein the point of interest comprises one selected from the group consisting of a selected location, a demographic area, a population density, a competitor location, a geographic area, and a second out-of-home advertisement.

8. The method of claim 1, further comprising the step of analyzing the content of the out-of-home advertisement.

9. A method of providing data related to an out-of-home advertisement, the method comprising the steps of:
collecting campaign metrics related to an out-of-home advertising campaign;
providing a database for storing the collected campaign metrics;
directing a field agent to verify information related to the out-of-home advertising campaign, wherein the information to be verified includes the date by which an out-of-home advertisement is posted;
collecting information related to traffic and loading the information into the database; and
providing an analysis of the data collected via a report.

10. The method of claim 9, wherein the information and report is provided via a secure website.

11. The method of claim 9, wherein the report includes an analysis of the visibility of the out-of-home advertisement, the traffic flow near the out-of-home advertisement, and the proximity of the out-of-home advertisement to at least one point of interest.

12. The method of claim 9, further comprising the step of identifying visibility problems.

13. The method of claim 9, further comprising the step of providing a point-of-interest map.

14. The method of claim 9, further comprising the step of assigning a unique identifier to the out-of-home advertisement.

15. The method of claim 11, wherein the analysis tracks the campaign metrics over time.

16. A method of providing data related to an out-of-home advertisement, the method comprising the steps of:
collecting campaign metrics related to an out-of-home advertising campaign;
providing a database for storing the collected campaign metrics;
collecting information related to the out-of-home advertising campaign, wherein the information includes the date by which an out-of-home advertisement is posted;
collecting information related to the demographics of a neighborhood near the out-of-home advertisement; and
providing an analysis of the data collected via a report.

17. The method of claim 16, wherein the report is provided via the Internet.

18. The method of claim 16, further comprising the step of analyzing the graphical and literary content of the out-of-home advertisement.

19. The method of claim 16, wherein the report includes an assessment of the drive-by traffic for the placement of the advertisement.

20. The method of claim 16, further comprising the step of identifying the visibility of the advertisment.
